(19) United States
(12) Patent Application Publication
(10) Pub. No.: US 2008/0075444 A1
(43) Pub. Date: Mar. 27, 2008

(54) BLUR EQUALIZATION FOR AUTO-FOCUSING

(76) Inventors: Murali Subbarao, Stony Brook, NY (US); Tao Xian, Bensalem, PA (US)

Correspondence Address: THE FARRELL LAW FIRM, P.C., 333 EARLE OVINGTON BOULEVARD, SUITE 701, UNIONDALE, NY, 11553, US

(21) Appl. No.: 11/861,029

(22) Filed: Sep. 25, 2007

Related U.S. Application Data
(60) Provisional application No. 60/847,035, filed on Sep. 25, 2006.

(51) Int. Cl. G03B 13/36

(52) U.S. Cl. 396/101; 396/126

(57) ABSTRACT

Disclosed is a spatial-domain Blur Equalization Technique that improves autofocusing performance and robustness for arbitrary scenes, providing better performance for autofocusing at low or high contrast scenes. In the present invention, binary masks are formed for removing background noise, and a switching mechanism based on reliability measure improves performance.

### PRIORITY

This application claims priority to application Ser. No. 60/847,035, filed Sep. 25, 2006, the contents of which are incorporated herein by reference.

### BACKGROUND

1. Field of the Invention

The present invention relates generally to a spatial-domain Blur Equalization Technique (BET) for improving autofocusing performance and, in particular, for improving autofocusing robustness for arbitrary scenes, at low or high contrast scenes.

2. Background of the Invention

Depth From Defocus (DFD) is an important passive autofocusing technique. A spatial domain approach is provided. However, the spatial domain approach has the inherent advantage of being local in nature, using only a small image region and yields a denser depth-map than the Fourier domain methods. Therefore, it is better for some applications such as continuous focusing, object tracking focusing, etc. Moreover, since it requires less computing resource than the frequency domain methods, the spatial domain approach is more suitable for real-time autofocusing applications.

A Spatial-domain Convolution/Deconvolution Transform (S Transform) has been developed for images and n-dimensional signals for the case of arbitrary order polynomials. For example, f(x,y) is an image that is a two-dimensional cubic polynomial defined by Equation (1):

$$f ( x , y ) = {\sum }_{m = 0}^{3} {\sum }_{n = 0}^{3 - m} {a}_{mn} {x}^{m} {y}^{n} \qquad ( 1 )$$

where aₘₙ are the polynomial coefficients. The restriction on the order of f is made to be valid by applying a polynomial fitting least square smoothing filter to the image.

Letting h(x,y) be a rotationally symmetric Point Spread Function (PSF), for a small region of the image detector plane, the camera system acts as a linear shift invariant system. The observed image g(x,y) is the convolution of the corresponding focused image f(x,y) and the PSF of the optical system h(x,y) as described by Equation (2):
g(x,y)=f(x,y) [symbol] h(x,y) (2)
where [symbol] denotes the convolution operation.

The moments of PSF h(x,y) are defined by Equation (3):

$${h}_{mn} = {\int }_{- ∞}^{+ ∞} {\int }_{- ∞}^{+ ∞} {x}^{m} {y}^{n} h ( x , y ) ⅆ x ⅆ y \qquad ( 3 )$$

and a spread parameter σₙ is used to characterize the different forms of the PSF, that can be defined as the square root of the second central moment of the function h. For a rotationally symmetric function, it is given by Equation (4):

$${σ}_{h}^{2} = {\int }_{- ∞}^{+ ∞} {\int }_{- ∞}^{+ ∞} ( {x}^{2} + {y}^{2} ) h ( x , y ) ⅆ x ⅆ y \qquad ( 4 )$$

From Spatial Domain Convolution/Deconvolution Transform (S Transform), the deconvolution between f(x,y) and g(x,y) in Equation (2) is described by Equation (5):

$$f ( x , y ) = g ( x , y ) - \frac{{h}_{20}}{2} [ {f}^{20} ( x , y ) + {f}^{02} ( x , y ) ] \qquad ( 5 )$$

Applying

$$\frac{{\partial }^{2}}{\partial {x}^{2}}$$

and

$$\frac{{\partial }^{2}}{\partial {y}^{2}}$$

to the above Equation (5) on either side, respectively, and noting that derivatives of order higher than three are zero for a cubic polynomial, we obtain Equation (6):
f²⁰(x,y)=g²⁰(x,y)
f⁰²(x,y)=g⁰²(x,y) (6)
Substituting Equation (6) into Equation (5) yields Equation (7):

$$f ( x , y ) = g ( x , y ) - \frac{{h}_{20}}{2} {∇}^{2} g ( x , y ) \qquad ( 7 )$$

Using the definitions of moments of hₘₙ and the definition of the spread parameter h(x,y), we have

$${h}_{20} = {h}_{02} = \frac{{σ}_{h}^{2}}{2} .$$

The above deconvolution formula can be written as Equation (8):

$$f ( x , y ) = g ( x , y ) - \frac{{σ}_{h}^{2}}{4} {∇}^{2} g ( x , y ) \qquad ( 8 )$$

For simplicity, the focused image f(x,y) and defocused images gᵢ(x,y), i=1, 2 are denoted as f and gᵢ for the following description.

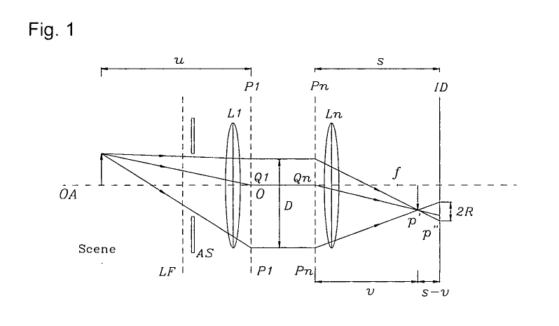

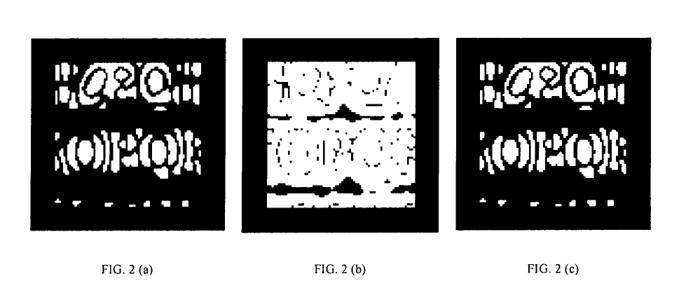

In regard to Spatial-domain convolution/deconvolution Transform Method (STM) Auto-Focusing (AF), FIG. 1 shows a multiple lens camera model, in which p is the object point; LF is the Light Filter; AS is the Aperture Stop (AS); L1 is a first lens; Ln is a last lens; Oa is an Optical axis; P1 is a first principal plane; Pn is a last principal plane; Q1 is a first principal point; ID is an Image Detector; s, f, and D are camera parameters; v is a distance of image focus; p′ is a focused image and p″ is a blurred image.

In conventional camera systems, there are a number of lens elements organized into groups to carry out optical imaging function. FIG. 1 shows a camera system with n lenses. The Aperture Stop (AS) is the element of the imaging system that physically limits the angular size of the cone of light accepted by the system. In a simple camera, the iris diaphragm acts as an aperture stop with variable diameter. The field stop is the element that physically restricts the size of the image. The entrance pupil is the image of the AS as viewed from the object space, formed by all the optical elements preceding it. However, this becomes an effectively limiting element for the angular size of the cone of light reaching the system. Similarly, the exit pupil is the image of aperture stop, formed by the optical elements following it. For a system of multiple lenses, the focal length will be the effective focal length f_{eff}; the object distance u will be measured from the first principal point (Q₁), the image distance v and the detector distance s will be calculated from the last principal point (Qₙ). Imaginary planes erected perpendicular to the optical axis at these points are known as the first principal plane (P₁) and the last principal plane (Pₙ) respectively.

If geometric optics is assumed, the diameter of the blur circle can be computed using the lens equation and the geometry as shown in FIG. 1, with a resulting radius of the blur circle that can be calculated by use of Equation (9):

$$\begin{matrix}R = \frac{f}{2 vF} \vert s - v \vert & ( 9 ) \\ {R}_{p} = \frac{R}{ρ} & ( 10 )\end{matrix}$$

where f is the effective focal length; F is the F-number; R is the radius of the blur circle; ρ is the size of a CCD pixel; Rₚ is the radius of the blur circle in pixels; v is the distance between the last principal plane and the plane where the object is focused; and s is the distance between the last principal plane and the image detector plane.

As shown in FIG. 1, if an object point p is not focused, then a blur circle p″ is detected on the image detector plane. From Equation (9), the radius of the blur circle is found as Equation (11):

$$R = \frac{Ds}{2} [ \frac{1}{f} - \frac{1}{u} - \frac{1}{s} ] \qquad ( 11 )$$

where f is the effective focal length, D is the diameter of the system aperture, R is the radius of the blur circle, u, v, and s, are the object distance, image distance, and detector distance respectively. The sign of R here can be either positive or negative depending on whether s≧v or s<v. After magnification normalization, the normalized radius of blur circle can be expressed as a function of camera parameter setting \vec{e} and object distance u as Equation (12):

$${R}^{′} ( \vec{e} , u ) = \frac{{Rs}_{0}}{s} = \frac{{Ds}_{0}}{2} [ \frac{1}{f} - \frac{1}{u} - \frac{1}{s} ] \qquad ( 12 )$$

If the polychromatic illumination, lens aberrations, etc. are considered, the PSF can be modeled as a two-dimensional Gaussian. Accordingly, the PSF is defined as Equation (13):

$$h ( x , y ) = \frac{1}{2 {πσ}_{n}^{2}} exp [ - \frac{{x}^{2} + {y}^{2}}{2 {σ}_{n}^{2}} ] \qquad ( 13 )$$

where σₙ is the spread parameter corresponding to the Gaussian PSF. In practice, it is found that σ is proportional to R′, as in Equation (14):
σ=kR′ for k>0 (14)
where k is a constant of proportionality characteristic of the given camera. If the apertures are not too small, and the diffraction effect can be ignored, then

$$k = \frac{1}{\sqrt{2}}$$

is a good approximation that is suitable in most practical cases.

Therefore, Equation (14) provides Equation (15):
σ=mu⁻¹+c (15)
where, as described in Equation (16):

$$m = - \frac{{Ds}_{0}}{2 k} and c = - \frac{{Ds}_{0}}{2 k} [ \frac{1}{f} - \frac{1}{s} ] \qquad ( 16 )$$

Letting g₁ and g₂ be the two images of a scene for two different parameter settings \vec{e₁}=(s₁, f₁, D₁) and \vec{e₂}=(s₂, f₂, D₂) provides Equation (17):
σ₁=mᵢu⁻¹+cᵢ, i=1,2 (17)
Therefore, Equation (18) provides:

$${u}^{- 1} = \frac{{σ}_{1} - {c}_{1}}{{m}_{1}} = \frac{{σ}_{2} - {c}_{2}}{{m}_{2}} \qquad ( 18 )$$

Rewriting Equation (18) yields Equation (19):
σ₁=ασ₂+β (19)
where, as shown in Equation (20):

$$α = \frac{{m}_{1}}{{m}_{2}} and β = {c}_{1} - {c}_{2} \frac{{m}_{1}}{{m}_{2}} \qquad ( 20 )$$

In conventional STM, a Laplacian assumption of a Laplacian of the first image being equal to Laplacian of the second image (∇²g₁=∇²g₂) is imposed. ∇²g₁=∇²g₂ is only valid under the third order polynomial assumption of Equation (1). However, for arbitrary scenes, the output from low pass filter may be higher than the third order polynomial. Thus ∇²g₁≠∇²g₂ is common in real applications. That means that the measurement accuracy of conventional STM is affected by the object to be measured, if the object's contrast is too high or too low.

To relax the assumption and to provide improved results, a new STM algorithm based on a Blur Equalization Scheme (BET) is presented.

Accordingly, the present invention utilizes BET to provide improved autofocusing performance at low contrast or high contrast scenes, and the present invention is new development of STM.

### SUMMARY OF THE INVENTION

The present invention substantially solves the above shortcoming of conventional devices and provides at least the following advantages.

The present invention provides improved autofocusing, in regard to Depth From Defocus (DFD), STM, blur equalization, and switching mechanism based on reliability measure.

In the present invention, binary masks are formed for removing background noise, and a switching mechanism based on reliability measure is proposed for improved performance.

Depth From Defocus (DFD) is an important passive autofocusing technique. The spatial domain approach has the inherent advantage of being local in nature. It uses only a small image region and yields a denser depth-map than Fourier domain methods. Therefore, better results are obtained for applications such as continuous focusing, object tracking focusing etc. Moreover, since less computing resources than the frequency domain methods are requires, the spatial domain approach is more suitable for real-time autofocusing applications.

### DETAILED DESCRIPTION OF THE FIGURES

The above and other objects, features and advantages of exemplary embodiments of the present invention will be more apparent from the following detailed description taken in conjunction with the accompanying drawings, in which:

FIG. 1 illustrates a multiple lens camera;

FIGS. 2(a)-(c) illustrate binary masks for BET of the present invention;

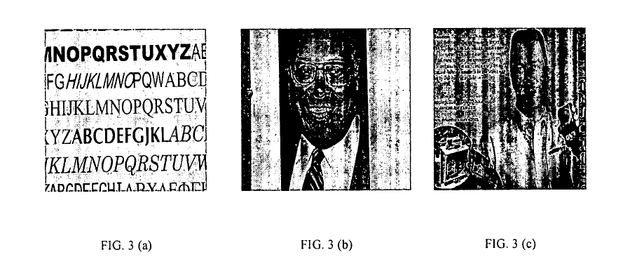

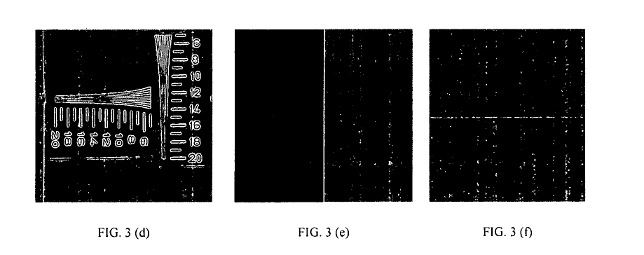

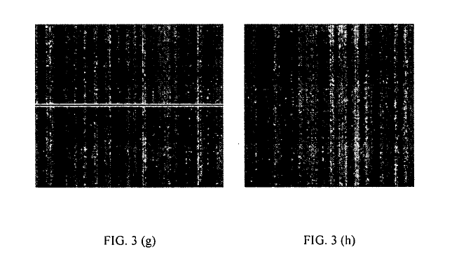

FIGS. 3(a)-(h) show positions of test objects;

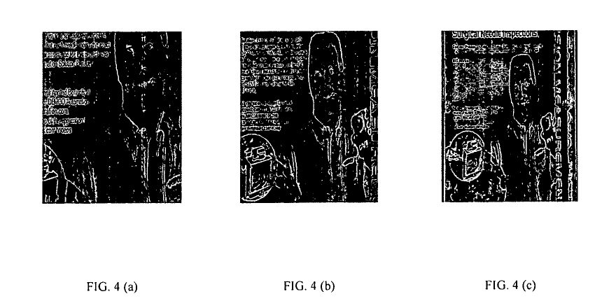

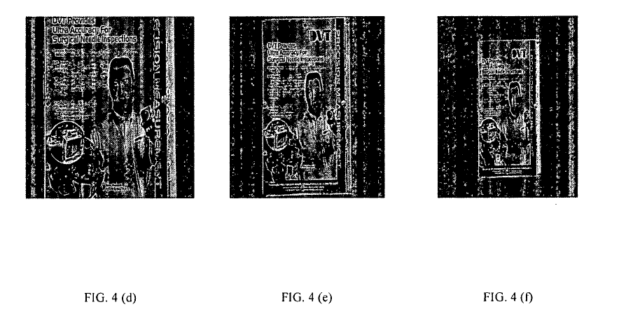

FIGS. 4(a)-(f) show test object at different positions;

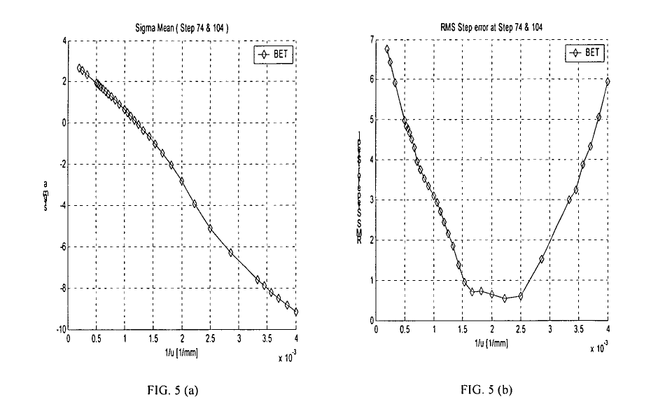

FIGS. 5(a)-(b) show sigma table and RMS step error for BET;

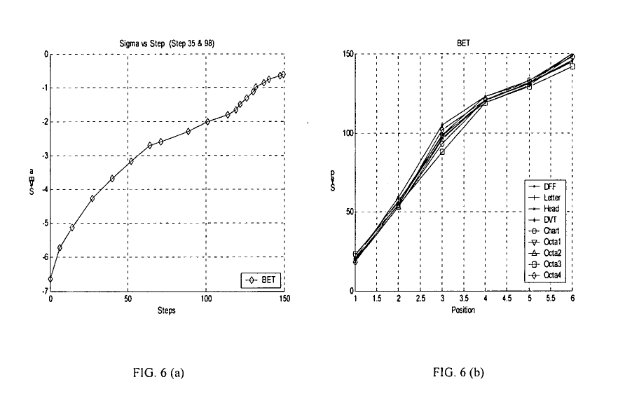

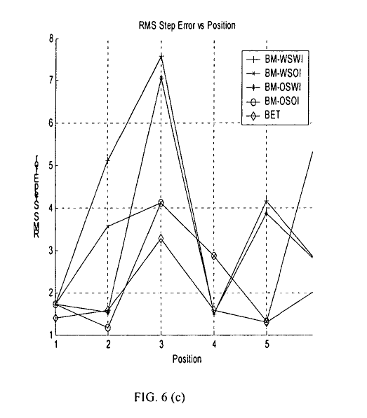

FIGS. 6(a)-(c) show measurement results for BET real data; and

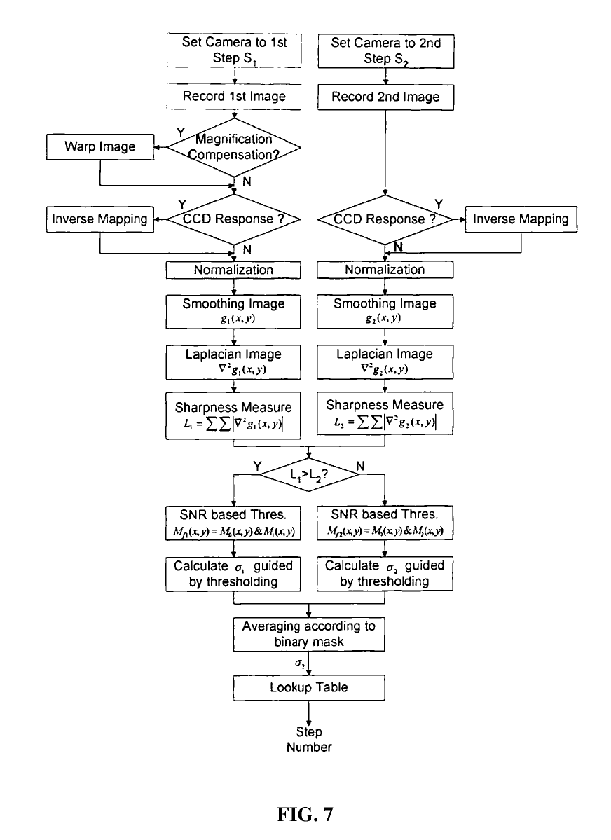

FIG. 7 is a flowchart of a BET algorithm of a preferred embodiment of the invention.

### DETAILED DESCRIPTION OF THE PREFERRED EMBODIMENTS

The below description of detailed construction of preferred embodiments provides to a comprehensive understanding of exemplary embodiments of the invention. Accordingly, those of ordinary skill in the art will recognize that various changes and modifications of the embodiments described herein can be made without departing from the scope and spirit of the invention. Descriptions of well-known functions and constructions are omitted for clarity and conciseness.

In a preferred embodiment of the present invention, two defocused images gᵢ(x,y), i=1,2 are expressed as described in Equation (21):
gᵢ(x,y)=f(x,y) [symbol] hᵢ(x,y), i=1,2 (21)
where hᵢ(x,y) is the PSF of corresponding defocused image at position i, resulting in Equations (22) and (23):
g₁(x,y) [symbol] h₂(x,y)=[f(x,y) [symbol] h₁(x,y)] [symbol] h₂(x,y) (22)
g₂(x,y) [symbol] h₁(x,y)=[f(x,y) [symbol] h₂(x,y)] [symbol] h₁(x,y) (23)

From the commutative property of convolution, the right side of Equation (22) equals the right side Equation (23), as shown in Equation (24):
g₁(x,y) [symbol] h₂(x,y)=g(x,y) [symbol] h₁(x,y) (24)

Using Forward S Transform for convolution provides Equations (25) and (26):

$$\begin{matrix}{g}_{1} ( x , y ) ⊗ {h}_{2} ( x , y ) = {g}_{1} ( x , y ) + \frac{{σ}_{2}^{2}}{4} {∇}^{2} {g}_{1} ( x , y ) + \frac{{σ}_{2}^{4}}{24} {( {∇}^{2} )}^{2} {g}_{1} ( x , y ) + R ( {O}^{6} ) & ( 25 ) \\ {g}_{2} ( x , y ) ⊗ {h}_{1} ( x , y ) = {g}_{2} ( x , y ) + \frac{{σ}_{1}^{2}}{4} {∇}^{2} {g}_{2} ( x , y ) + \frac{{σ}_{1}^{4}}{24} {( {∇}^{2} )}^{2} {g}_{2} ( x , y ) + R ( {O}^{6} ) & ( 26 )\end{matrix}$$

Combining Equations (24), (25) and (26), and ignoring the higher order terms R(O⁴,O⁶), provides Equation (27):

$${g}_{1} ( x , y ) + \frac{{σ}_{2}^{2}}{4} {∇}^{2} {g}_{1} ( x , y ) + \frac{{σ}_{1}^{2}}{4} {∇}^{2} {g}_{2} ( x , y ) \qquad ( 27 )$$

Using Equation (15), Equation (28) is obtained:
a₁σ₁²+b₁σ₁+c₁=0 (28)
where the coefficients are defined as Equations (29)-(31):

$$\begin{matrix}{a}_{1} = \frac{{∇}^{2} {g}_{2}}{{∇}^{2} {g}_{1}} - 1 & ( 29 ) \\ {b}_{1} = 2 β & ( 30 ) \\ {c}_{1} = - [ \frac{4 ( {g}_{1} - {g}_{2} )}{{∇}^{2} {g}_{1}} + {β}^{2} ] & ( 31 )\end{matrix}$$

In an embodiment of the present invention, two binary masks are formed. Laplacian Mask M₀(x,y) is formed by thresholding Laplacian, and Delta Mask M₁(x,y) guarantees the real property of the solution, as shown in Equations (32)-(33):

$$\begin{matrix}{M}_{0} ( x , y ) = \{ \begin{matrix}1 & {∇}^{2} {g}_{2} \geq T \\ 0 & o . w .\end{matrix} , ( x , y ) ∈ W & ( 32 ) \\ {M}_{1} ( x , y ) = \{ \begin{matrix}1 & {Δ}_{1} \geq 0 \\ 0 & o . w .\end{matrix} , ( x , y ) ∈ W & ( 33 )\end{matrix}$$

where Δ₁=b₁²−4a₁c₁.

A final binary mask M_{f1}(x,y) is obtained from the BIT-AND operation as shown in Equation (34):
M_{f1}(x,y)=M₀(x,y) & M₁(x,y) (34)
where & is the BIT-AND operator for binary mask. Then the computation of σ₁ is guided by M_{f1}(x,y), and the best estimation of σ₁ is considered as the average based on M_{f1}(x,y).

FIG. 2 shows binary masks for the BET of a preferred embodiment of the present invention. In FIG. 2(a) a Laplacian Mask M₀(x,y) is shown, in FIG. 2(b) a Delta Mask M₁(x,y) is shown, and in FIG. 2(c) the Final Binary Mask M_{f1}(x,y) is shown.

In regard to a switching mechanism based on a reliability measure of a preferred embodiment of the present invention, another quadratic equation regarding σ₂ can also be derived from Equation (11) and Equation (18), and the binary mask M_{f2}(x,y) is formed similar to Equations (32)-(34), as shown in Equation (35):
a₂σ₂²+b₂σ₂+c₂=0 (35)
with coefficients as shown in Equations (36)-(38):

$$\begin{matrix}{a}_{2} = 1 - \frac{{∇}^{2} {g}_{1}}{{∇}^{2} {g}_{2}} & ( 36 ) \\ {b}_{2} = 2 β & ( 37 ) \\ {c}_{2} = - [ \frac{4 ( {g}_{1} - {g}_{2} )}{{∇}^{2} {g}_{2}} - {β}^{2} ] & ( 38 )\end{matrix}$$

In theory, Equations (28)-(31) and Equations (35)-(38) should be identical. However, it has been found that the two equations sets have different working range due to Laplacian mask formation. Accordingly, the present invention utilizes in preferred embodiments a switching mechanism based on a reliability measure that obtains better accuracy, even for high-contrast content. A sum of Laplacian is defined in the focusing window

$${L}_{i} = {\sum }_{x} {\sum }_{y} \vert {∇}^{2} {g}_{i} ( x , y ) \vert , i = 1 , 2$$

as the reliability measure. The switching mechanism is formulated as Equation (39):

$$\{ \begin{matrix}{a}_{1} {σ}_{1}^{2} + {b}_{1} {σ}_{1} + {c}_{1} = 0 & {σ}_{2} = {σ}_{1} + β & {L}_{1} > {L}_{2} \\ {σ}_{2} = β / 2 & & {L}_{1} \approx {L}_{2} \\ {a}_{2} {σ}_{2}^{2} + {b}_{2} {σ}_{2} + {c}_{2} = 0 , & & {L}_{1} < {L}_{2}\end{matrix} \qquad ( 39 )$$

Guided by this Laplacian reliability measure, the final sigma table improves the linearity and stability compared with directly using Equations (28)-(31) or Equations (35)-(38).

Utilizing a preferred embodiment of the BET algorithm that is described above, an Olympus C3030 camera controlled by a host computer (Pentium 4 2.4 GHz) via a USB port was arranged. A lens focus motor having C3030 ranges from 0 to 150, with a step 0 corresponding to focusing a nearby object at a distance of about 250 mm from the lens and a step 150 corresponding to focusing an object at a distance of infinity.

Eight difficult-to-measure objects were photographed, as shown in FIGS. 3(a)-(h) to confirm the DFD algorithm capabilities. Six positions are randomly selected. The distance and the corresponding steps are listed in Table 1, which provides object positions in the DFD experiment. Test objects positions are shown in FIGS. 4(a)-(f), with an F-number set to 2.8, and focal length set to 19.5 mm, a focusing window located at the center of the scenes, a window size of 96*96, and Gaussian smoothing and LoG filters of 9*9 pixels.

TABLE 1

| | Position 1 | Position 2 | Position 3 | Position 4 | Position 5 | Position 6 |
|---|---|---|---|---|---|---|
| Distance [mm] | 32.5 | 47.3 | 62.6 | 78.2 | 105.5 | 135.0 |
| Step | 19.00 | 55.00 | 96.50 | 120.50 | 131.25 | 144.75 |

FIG. 3 shows the test objects, with FIG. 3(a) showing letter, FIG. 3(b) showing head, with FIG. 3(c) showing DVT, with FIG. 3(d) showing a chart, with FIG. 3(e) showing Ogata Chart 1, with FIG. 3(f) showing Ogata Chart 2, with FIG. 3(g) showing Ogata Chart 3, and with FIG. 3(h) showing Ogata Chart 4. FIGS. 4(a)-(f) show a test object at different positions, with FIG. 4(a) showing Position 1, with FIG. 4(b) showing position 2, with FIG. 4(c) showing position 3, with FIG. 4(d) showing position 4, with FIG. 4(e) position 5, with FIG. 4(f) showing position 6.

The performance evaluation of BET was preformed using both simulation and real data, with the same configuration and parameters for simulation and experiment as above. FIG. 5(a) shows the sigma table for simulation and FIG. 5(b) shows the corresponding RMS Step error. The results for real experiments are shown in FIG. 6, with FIGS. 6(a)-(c) showing measurement results for BET real data. FIG. 6(a) shows a Sigma-Step Table, FIG. 6(b) shows measurement results for 9 test objects, and FIG. 6(c) show RMS step error versus position. Comparison of BET's error performance with several other competing techniques (labeled BM_WSWI, BM_WSOI, BM_OSWI, and BM_OSOI in FIG. 6(c)) shows that the RMS step error has been effectively reduced at both the near field and the far field. The results of the method of the present invention are further improved with proper selection the step interval or use of an additional image.

As described above and as demonstrated in regard to synthetic and real data, the present invention provides improvements to STM1 as well as STM2, and are applicable to other spatial domain based algorithms.

While this invention has been particularly shown and described with reference to preferred embodiments thereof, it will be understood by those skilled in the art that various changes in form and details may be made therein without departing from the scope of the invention encompassed by the appended claims.

What is claimed is:

1. An autofocusing method by recovering depth information, the method comprising:
recording two different images of a subject using different camera parameters;
establishing a relation that equalizes blur between said two different images in terms of a degree of blur;
computing the degree of blur;
recovering depth; and
autofocusing the camera.

2. The autofocusing method of claim 1, wherein the autofocusing is performed in real time.

3. The autofocusing method of claim 1, wherein autofocusing performance and robustness are improved by using a binary mask for reducing noise.

4. The autofocusing method of claim 1, wherein an S transform is utilized in a convolutional mode.

5. The autofocusing method of claim 1, wherein each of the two images are blurred images.

6. The autofocusing method of claim 1, further comprising discarding pixels with low Signal-to-Noise ratio via threshold image Laplacians, thereby increasing reliance on sharper of the two images.

7. The autofocusing method of claim 1, wherein autofocusing is improved at low and high contrast scenes.

8. The autofocusing method of claim 1, wherein Laplacian Mask M₀(x,y) is formed by thresholding Laplacian and a Delta Mask M₁(x,y) provides a real property of a solution, utilizing equations:
$$\begin{matrix}{M}_{0} ( x , y ) = \{ \begin{matrix}1 & {∇}^{2} {g}_{2} \geq T \\ 0 & o . w .\end{matrix} , ( x , y ) ∈ W \\ and \\ {M}_{1} ( x , y ) = \{ \begin{matrix}1 & {Δ}_{1} \geq 0 \\ 0 & o . w .\end{matrix} , ( x , y ) ∈ W \\ where {Δ}_{1} = {b}_{1}^{2} - 4 {a}_{1} {c}_{1} .\end{matrix}$$

9. The autofocusing method of claim 1, wherein a switching mechanism based on reliability measure is provided.

10. The autofocusing method of claim 9, wherein the switching mechanism is formulated by use of equation:
$$\{ \begin{matrix}{a}_{1} {σ}_{1}^{2} + {b}_{1} {σ}_{1} + {c}_{1} = 0 & {σ}_{2} = {σ}_{1} + β & {L}_{1} > {L}_{2} \\ {σ}_{2} = β / 2 & & {L}_{1} \approx {L}_{2} \\ {a}_{2} {σ}_{2}^{2} + {b}_{2} {σ}_{2} + {c}_{2} = 0 , & & {L}_{1} < {L}_{2} .\end{matrix}$$
